(19) United States
(12) Patent Application Publication
(10) Pub. No.: US 2017/0126927 A1
(43) Pub. Date: May 4, 2017

(54) Card printer automat for producing unique plastic cards

(71) Applicant: László JÁGER, Nyíregyháza (HU)

(72) Inventor: László JÁGER, Nyíregyháza (HU)

(21) Appl. No.: 15/341,056

(22) Filed: Nov. 2, 2016

Related U.S. Application Data
(60) Provisional application No. 62/249,398, filed on Nov. 2, 2015.

(51) Int. Cl. H04N 1/32; H04N 1/00; G05B 19/042

(52) U.S. Cl. CPC H04N 1/32523; G05B 19/042; H04N 1/00244; H04N 1/00278; H04N 1/00334; G05B 2219/2646

(57) ABSTRACT

The card-printing vending machine (10) comprises a processor-based control unit (12), a touch-screen (14) electronically connected thereto, a card-printing unit (16) provided with a card holder (17) for storing a plurality of unprinted plastic cards, and a bank card reading unit (18), which are all arranged in a house. A communication interface (20) for establishing an interconnection with a remote database storing a plurality of card designs is electronically connected to the control unit (12).

This application claims priority to U.S. provisional application 62/249,398, filed Nov. 2, 2015, the disclosure of which is hereby incorporated by reference herein.

The present invention relates to a card-printing vending machine for producing unique plastic cards.

Document WO 2008/115522 discloses a vending machine for producing a gift card, which allows customers to uniquely design gift cards by using card templates stored in a database of the vending machine, by filling out predetermined data fields and by adding images or graphical elements thereto, and then to print and to immediately activate the gift cards by using the kiosk.

A drawback of the above card-printing vending machine is that preparation of the unique card designs is linked to the vending machine therefore the customers have to spend a longer time at the vending machine while others have no access to the vending machine neither to design, nor to print a card. A further drawback is that the cards individually designed by using templates are not stored (for data security reasons) in the vending machine, therefore the prepared card designs become lost after printing the card.

It is an object of the present invention to provide a card-printing vending machine which allows immediate printing of customized cards and which is connected to a central database, from which the previously stored, unique card designs are accessible through any other vending machine too.

The above objects are achieved by providing a card-printing vending machine, which comprises a processor-based control unit, a touch-screen electronically connected thereto, a card-printing unit provided with a card holder storing unprinted plastic cards, and a bank card reading unit, which are all arranged in a house. A communication interface connected to a remote database storing a plurality of card designs is electronically connected to said control unit.

A paper card printer, a receipt printing unit, a sticker printer (preferably for printing a single-row sticker band) and a scanner can be electronically connected to the control unit.

It is preferred that the house of the card-printing machine is provided with an LCD display, preferably at its upper part.

The invention will now be described with reference to the drawings, in which:

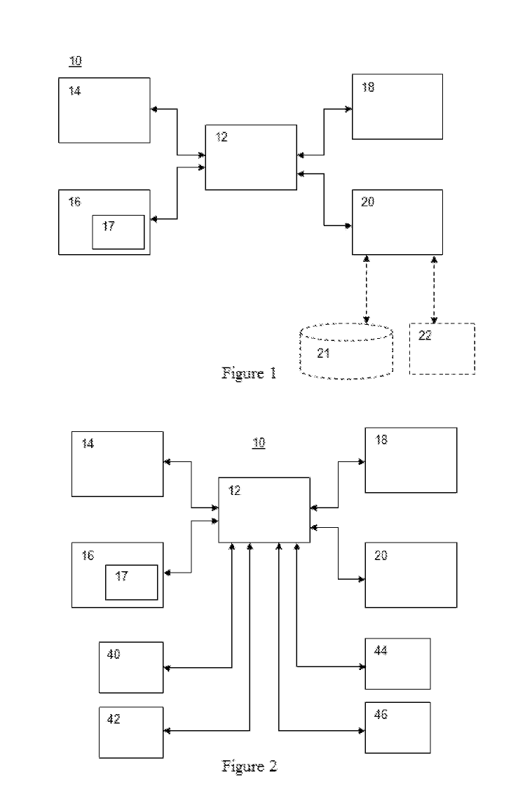

FIG. 1 illustrates a functional block diagram of the card-printing vending machine according to the present invention;

FIG. 2 depicts a functional block diagram of a preferred embodiment of the card-printing vending machine according to the present invention.

As shown in FIG. 1, a card-printing vending machine 10 according to the present invention comprises a processor-based control unit 12, a touch-screen 14, a printing unit 16, a bank card reading unit 18 and a communication interface 20. These components are arranged in an ergonomic, vandal-resistant house.

The touch-screen 14, the printing unit 16, the bank card reading unit 18 and the communication interface 20 are electronically connected to the processor-based control unit 12.

The touch-screen 14 forms a data input-output device which allows the user to use the card-printing vending machine 10. Preferably, the touch-screen 14 provides a color graphical user interface to access the functions of the card-printing vending machine. By means of the application displayed on the touch-screen 14 the user can browse, according to different criteria, among a plurality of unique card designs stored in a central database 21 and then he or she can print any number of copies of the plastic card presenting the selected card design.

The plastic cards are printed by the printing unit 16, which has a card holder 17 for storing blank (unprinted) plastic cards. The operation of the printing unit 16 is preferably based on a re-transfer printing technique.

As shown in FIG. 2, a preferred embodiment of the card-printing vending machine 10 according to the present invention is further provided with a paper card printer 40, which also allows the production of paper-based gift cards. The paper card printer 40 is electronically connected to the control unit 12.

Preferably, the card-printing vending machine 10 according to the present invention further comprises a receipt printing unit 42 which allows printing, for example, a receipt or an invoice at payment on the spot.

As shown in FIG. 2, the receipt printing unit 42 is electronically connected to the control unit 12 too.

As shown in FIG. 2, the card-printing vending machine 10 according to the present invention may optionally comprise a sticker printer 44 (preferably for printing a single-row sticker band), which is electronically connected to the control unit 12. In addition to the production of new cards, the sticker printer 44 may also be adapted for printing unique validating stickers for plastic cards which can be validated or revalidated by such stickers.

A preferred embodiment of the card-printing vending machine 10 according to the present invention shown in FIG. 2 may further comprise a scanner 46, which allows, for example, reading of a bar code or a QR code. This function may be of importance when the user has previously selected a card design (for example on his/her own computer via the internet) and after payment the plastic card with a selected and already paid card design can be printed by means of the card-printing vending machine according to the present invention using said code. The scanner 46 is additionally suitable for reading other visual identification information (e.g. bar code of a membership card) relating to the user in order to identify the user. The scanner 46 is also electronically connected to the control unit 12.

To allow a user to pay on the spot for a prepared plastic card, the card-printing vending machine 10 according to the present invention allows the payment with a bank card through the bank card reading unit 18.

The card-printing vending machine 10 according to the present invention establishes a communication interconnection through the communication interface 20, preferably via the internet, with a remote server 22 of a financial institute at payment with a bank card, and with the central database 21 during a search among the card designs. The communication interface 20 may be adapted for establishing either wired or wireless (e.g. GSM) connection.

In a particularly preferred embodiment of the card-printing vending machine according to the present invention, the house of the vending machine is equipped with an LCD display, preferably at the upper part of the house, said display having a substantially large surface. Such a display may be used primarily as an advertising surface.

In addition to the above mentioned units, the card-printing vending machine 10 according to the present invention further comprises numerous other common units (not shown in the drawings), including, for example, a power supply, a loudspeaker, etc., the way of use of which and the connections of which to the above parts are well-known for a skilled person, therefore their detailed description is omitted here.

The advantage of the card-printing vending machine according to the present invention is that it allows downloading a ready-to-use card design from an online database and the local and immediate printing of the plastic card, optionally with providing the card with unique information given by the customer (or information previously associated with customer, once the customer has already been identified).

1. A card-printing vending machine (10), comprising a processor-based control unit (12), a touch-screen (14) electronically connected thereto, a card-printing unit (16) provided with a card holder (17) for storing a plurality of unprinted plastic cards, and a bank card reading unit (18), which are all arranged in a house,
characterized in that
a communication interface (20) for establishing an interconnection with a remote database storing a plurality of card designs is electronically connected to said control unit (12).

2. The card-printing vending machine according to claim 1, wherein a paper card printer is electronically connected to the control unit (12).

3. The card-printing vending machine according to claim 1, wherein a receipt printing unit is electronically connected to the control unit (12).

4. The card-printing vending machine according to claim 1, wherein a sticker printer, preferably for printing a single-row sticker band, is electronically connected to the control unit (12).

5. The card-printing vending machine according to claim 1, wherein a scanner is electronically connected to the control unit (12).

6. The card-printing vending machine according to claim 1, wherein the house (30) is equipped with an LCD display, preferably at the upper part thereof.
